(19) United States
(12) Patent Application Publication
(10) Pub. No.: US 2015/0298510 A1
(43) Pub. Date: Oct. 22, 2015

(54) Pneumatic Tire

(71) Applicant: THE YOKOHAMA RUBBER CO., LTD., Tokyo (JP)

(72) Inventors: Masatoshi Shimizu, Hiratsuka-shi, Kanagawa (JP); Masatoshi Kuriyama, Kiratsuka-shi, Kanagawa (JP); Shinya Harikae, Kiratsuka-shi, Kanagawa (JP)

(21) Appl. No.: 14/648,681

(22) PCT Filed: Nov. 29, 2013
(86) PCT No.: PCT/JP2013/082241

§ 371 Date: May 29, 2015

(30) Foreign Application Priority Data
Nov. 30, 2012 (JP) 2012-263191

(51) Int. Cl. B60C 15/00; B60C 5/00; B60C 9/18; B60C 15/06; B60C 9/02

(52) U.S. Cl. CPC B60C 15/0036; B60C 15/0027; B60C 15/0603; B60C 15/0607; B60C 9/02; B60C 9/18; B60C 5/00

(57) ABSTRACT

A pneumatic tire in which two carcass layers including carcass cords are laid between a pair of bead portions. Bead cores and bead fillers are disposed in the bead portions. At least two belt layers are disposed on the outer circumferential side of the carcass layers. Both ends of the inner carcass layer are folded back from the tire inner side to the tire outer side around the bead cores. The ends of the folded back portions of the inner carcass layer are disposed between the innermost belt layer and the outer carcass layer, while both ends of the outer carcass layer are disposed so as to pass between a main portion of the inner carcass layer and the bead fillers. Both ends of the outer carcass layer terminate at the bead portions without being folded back around the bead cores.

### TECHNICAL FIELD

The present technology relates to a pneumatic tire provided with a plurality of carcass layers, and, more specifically, to a pneumatic tire that allows for reduced tire weight and rolling resistance while maintaining good steering stability, and allows for improved separation resistance.

### BACKGROUND

A reinforcing structure in which a plurality of carcass layers is laid between a pair of bead portions in order to maintain high internal pressure is used in pneumatic tires. For example, a pneumatic tire has been proposed in which three carcass layers are laid between a pair of bead portions, and both ends of the two inner carcass layers are folded back from a tire inner side to a tire outer side around bead cores, while both ends of the outermost carcass layer are disposed to the outer side of the folded back portions of the inner carcass layers in a tire width direction (for example, see Japanese Unexamined Patent Application Publication No. H11-321217A).

FIG. 6 schematically illustrates a conventional pneumatic tire comprising three carcass layers. As illustrated in FIG. 6, both ends of inner carcass layers 41, 42 are folded back from the tire inner side to the tire outer side around a bead core 5, and both ends of an outer carcass layer 43 are disposed to the outer side of the folded back portions of the inner carcass layers 41, 42. In a pneumatic tire with such a configuration, the presence of the three carcass layers 41, 42, 43 in the side wall portions allows for excellent steering stability.

However, pneumatic tires are frequently subjected to severe usage conditions, such as high load states caused by vehicle overloading or high internal pressure states intended to ensure load capacity; thus, if the ends of multiple carcass layers are disposed at locations of the bead portions or side wall portions where flexing tends to occur, separation failure originating at these ends easily occurs. In addition, the use of three carcass layers also increases the tire weight, lead to a problematic increase in the rolling resistance of the tire.

The problems described above can be overcome by reducing the number of carcass layers, but this will reduce the rigidity of the tire as a whole, potentially reducing steering stability.

### SUMMARY

The present technology provides a pneumatic tire that allows for reduced tire weight and rolling resistance while maintaining good steering stability, and allows for improved separation resistance.

A pneumatic tire of the present technology is a pneumatic tire in which two carcass layers including a plurality of carcass cords are laid between a pair of bead portions, bead cores and bead fillers are disposed in the bead portions, and at least two belt layers are disposed on the outer circumferential side of the carcass layers, the tire being characterized in that both ends of the inner carcass layer are folded back from the tire inner side to the tire outer side around the bead cores, and the ends of the folded back portions of the inner carcass layer are disposed between the innermost belt layer and the outer carcass layer, while both ends of the outer carcass layer are disposed so as to pass between a main portion of the inner carcass layer and the bead fillers, and both ends of the outer carcass layer terminate at the bead portions without being folded back around the bead cores.

In the present technology, both ends of the inner carcass layer are folded back from the tire inner side to the tire outer side around the bead cores, and the folded back portions of the inner carcass layer extend to a position overlapping the innermost belt layer, while both ends of the outer carcass layer terminate at the bead portions without being folded back around the bead cores, with the result that the carcass layers form a three-ply structure at the side wall portions that ensures sufficient rigidity on the part of the pneumatic tire, allowing for excellent steering stability. Meanwhile, only two carcass layers are used for the framework of the tire, eliminating as much of the excess portions of the carcass layers as possible, with the result that the tire weight, and, in addition, the rolling resistance of the tire, can be reduced compared to a pneumatic tire provided with three carcass layers as in the prior art.

In accordance with the arrangement of the present technology as described above, there are carcass layer ends at two locations per side of the tire, one of which is at a position at which there is little strain between the innermost belt layer and the outer carcass layer, thereby suppressing separation failure originating from the ends of the carcass layers and allowing for improved separation resistance.

In the present technology, the relationship of the height FH of the bead fillers in the tire radial direction to the tire cross-sectional height SH is preferably such that 0.05(SH)≦FH≦0.5(SH). This arrangement ensures that the bead portions have high bending rigidity and suppresses bending deformation on the part of the bead fillers when in contact with the ground, thereby allowing for a reduction in the tensile force placed upon the ends of the outer carcass layer adjacent to the bead fillers. This arrangement improves separation resistance and suppresses heat build-up and fatigue failure in the bead fillers.

The bead fillers are preferably divided with respect to the tire radial direction into inner fillers and outer fillers, with the ends of the outer carcass layer being disposed adjacent to the inner filler, and the outer filler having a JIS (Japanese Industrial Standard) hardness that is at least three points lower than the JIS hardness of the inner filler. As a result, it is possible to reduce the proportion of the bending deformation in the bead fillers as a whole that is placed upon the inner fillers adjacent to the ends of the outer carcass layer, allowing for a reduction in the tensile force placed upon the ends of the outer carcass layer. This arrangement improves separation resistance and suppresses heat build-up and fatigue failure in the bead fillers.

The inner filler preferably has a breaking strength of 15 MPa to 25 MPa and a loss tangent at 60° C. of 0.10 to 0.25. This allows heat build-up and fatigue failure in the inner filler adjacent to the ends of the outer carcass layer to be suppressed. Reducing the loss tangent of the inner filler also contributes to reduced tire rolling resistance.

The height FOH in the tire radial direction at the intersection between a boundary line separating the inner filler and the outer filler and the outer contour line of the bead filler and the height FIH in the tire radial direction at the intersection between the boundary line separating the inner filler and the outer filler and the inner contour line of the bead filler preferably have relationships with the height FH of the bead filler in the tire radial direction such that 0.1(FH)≦FOH≦0.4(FH) and 0.6(FH)≦FIH≦0.9(FH), respectively. Having the boundary line separating the inner filler and the outer filler be oblique with respect to the tire width direction according to the relationships described above creates a gradual change in the rigidity of the bead filler as a whole along the tire radial direction, mitigates stress concentration at the boundary between the inner filler and the outer filler, and improves separation resistance.

The height PH of the bead cores in the tire radial direction from the innermost end in the tire radial direction to the ends of the outer carcass layer preferably has a relationship with the height FIH in the tire radial direction at the intersection between the boundary line separating the inner filler and the outer filler and the inner contour line of the bead filler and the height BH of the bead cores in the tire radial direction such that 0.05×(BH+FIH)≦PH≦0.7×(BH+FIH). This makes the positions of the ends of the outer carcass layer appropriate and allows for improved separation resistance.

The overlap W between the folded back portions of the inner carcass layer and the innermost belt layer is preferably from 5 mm to 40 mm. This ensures excellent separation resistance.

A cushioning rubber layer having a thickness of 0.5 mm to 2 mm and a breaking strength of at least 20 MPa is preferably disposed between the folded back portions of the inner carcass layer and the innermost belt layer. This mitigates shearing strain at the location in question and allows for improved separation resistance.

It is preferable that the outer end of the cushioning rubber layer in the tire width direction be disposed further outward in the tire width direction than the end of the innermost belt layer, and that the inner end of the cushioning rubber layer in the tire width direction be disposed further inward in the tire width direction than the end of the folded back portion of the inner carcass layer. This allows for effective mitigation of shearing strain at the location in question.

A supplementary filler having a JIS hardness that is at least three points lower than the inner filler is preferably provided further outward in the tire width direction than the folded back portions of the inner carcass layer in the bead portion. The addition of this supplementary filler suppresses bending deformation in the bead fillers and allows the tensile force placed upon the ends of the outer carcass layer to be reduced. This arrangement improves separation resistance and suppresses heat build-up and fatigue failure in the bead fillers.

It is preferable that the outer end of the supplementary filler in the tire radial direction be disposed further outward in the tire radial direction than the outer ends of the bead fillers in the tire radial direction, and that the inner ends of the supplementary filler in the tire radial direction be disposed within the range of the height FH of the bead fillers in the tire radial direction. This arrangement allows for the effective suppression of bending deformation in the bead fillers.

It is preferable that the height SFH of the supplementary fillers in the tire radial direction have a relationship with the height FH of the bead fillers in the tire radial direction such that 0.5(FH)≦SFH≦1.5(FH), that the supplementary fillers be shaped so as to grow progressively thinner on both sides in the tire radial direction, and that the section of maximum thickness of the supplementary fillers be disposed within the range of the height FH of the bead fillers in the tire radial direction. This arrangement effectively suppresses bending deformation of the bead fillers without excessively increasing weight, allowing for improved durability.

In the present technology, “JIS hardness” is durometer hardness as measured according to JIS K-6253 using a type A durometer at a temperature of 20° C. “Breaking strength” is tensile strength as measured according to JIS K-6251 using a dumbbell-shaped test piece at a temperature of 20° C. Loss tangent (tan δ) is as measured according to JIS-K 6394 using a viscoelastic spectrometer (manufactured by Toyo Seiki Seisaku-sho, Ltd.) at a frequency of 20 Hz, an initial strain of 10%, a dynamic strain of ±2%, and a temperature of 60° C.

### BRIEF DESCRIPTION OF THE DRAWINGS

FIG. 1 is a meridian cross-sectional view illustrating a pneumatic tire according to an embodiment of the present technology.

FIG. 2 is a half cross-sectional view taken along a meridian of the pneumatic tire of FIG. 1.

FIG. 3 is a magnified cross-sectional view of a bead portion of the pneumatic tire of FIG. 2.

FIG. 4 is a half cross-sectional view taken along a meridian of a pneumatic tire according to another embodiment of the present technology.

FIG. 5 is a magnified cross-sectional view of a bead portion of the pneumatic tire of FIG. 4.

FIG. 6 is a schematic meridian cross-sectional view of a conventional pneumatic tire having three carcass layers.

### DETAILED DESCRIPTION

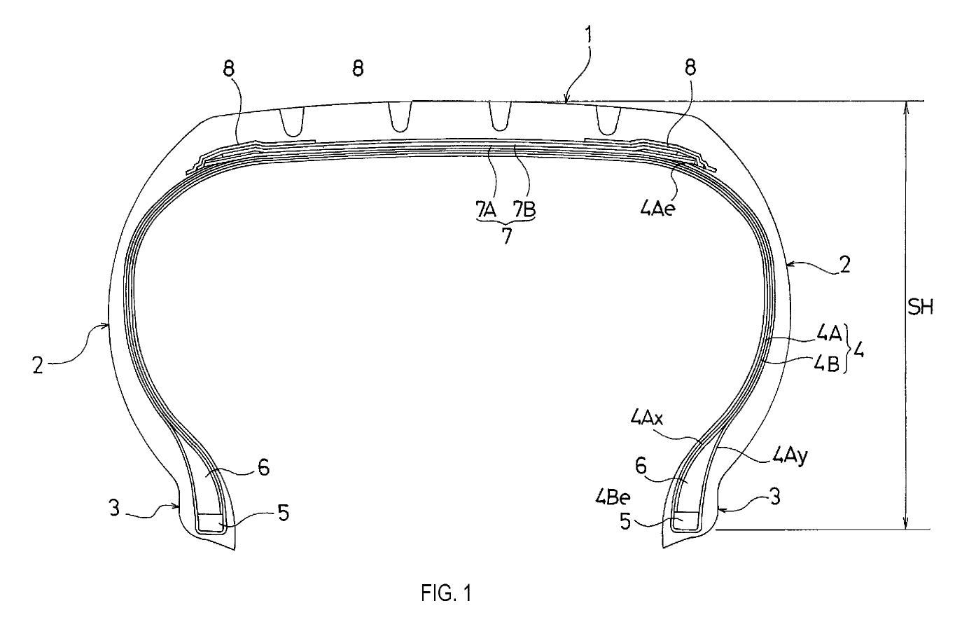

The following is a detailed description of the features of the present technology with reference to the accompanying drawings. FIGS. 1 to 3 illustrate a pneumatic tire according to an embodiment of the present technology.

As illustrated in FIG. 1, the pneumatic tire of the present embodiment is provided with a tread portion 1 extending in the tire circumferential direction in an annular shape, a pair of side wall portions 2 disposed on both sides of the tread portion 1, and a pair of bead portions 3 disposed on the inner side of the side wall portions 2 in the tire radial direction.

Two carcass layers 4 including a plurality of carcass cords that extend in the tire radial direction are laid between the pair of bead portions 3, 3. The carcass layers 4 include an inner carcass layer 4A positioned to the inside in the tire radial direction in the tread portion 1 and an outer carcass layer 4B positioned to the outside in the tire radial direction in the tread portion 1. Organic fiber cords of nylon, polyester, or the like are preferably used as the carcass cords constituting the two carcass layers 4. Annular bead cores 5 are embedded within the bead portions 3, and bead fillers 6 made of a rubber composition and having a triangular cross section are disposed on the outer peripheries of the bead cores 5.

At least two belt layers 7 are embedded in the outer peripheries of the carcass layers 4 in the tread portion 1. The belt layers 7 include an innermost belt layer 7A positioned to the inside in the tire radial direction and an outermost belt layer 7B positioned to the outside in the tire radial direction. The belt layers 7 include a plurality of reinforcing cords that are oblique with respect to the tire circumferential direction, and are disposed so that the reinforcing cords of different layers intersect each other. In the belt layers 7, the angle of the reinforcing cords with respect to the tire circumferential direction is set in a range of, for example, 10° to 40°. Steel cords are preferably used as the reinforcing cords of the belt layers 7.

For the purpose of enhancing high-speed durability, at least one belt cover layer 8 formed by arranging reinforcing cords at an angle of not more than 5° with respect to the tire circumferential direction is disposed on the outer circumferential side of the belt layers 7. The belt cover layer 8 preferably has a jointless structure in which a strip material made from at least a single reinforcing cord laid in parallel and covered with rubber is wound continuously in the tire circumferential direction. The belt cover layer 8 can also be disposed so as to cover the belt layers 7 at all positions along the width direction, or so as to cover only the outer edge portions of the belt layers 7 in the width direction. Nylon, aramid, or similar organic fiber cords are preferably used as the reinforcing cords of the belt cover layer 8.

In the pneumatic tire described above, both ends of the inner carcass layer 4A are folded back from the tire inner side to the tire outer side around the bead cores 5, and are disposed so as to enfold the bead cores 5 and the bead fillers 6. The inner carcass layer 4A comprises an interior main portion 4Ax and an exterior folded back portion 4Ay, the bead core 5 constituting the boundary between the two. An end 4Ae of the folded back portion 4Ay of the inner carcass layer 4A is disposed between the innermost belt layer 7A and the outer carcass layer 4B. Meanwhile, both ends of the outer carcass layer 4B are disposed so as to pass between the main portions 4Ax of the inner carcass layers 4A and the bead fillers 6, and both ends of the outer carcass layer 4B terminate at the bead portions 3 without being folded back around the bead cores 5. That is, ends 4Be of the outer carcass layer 4B are disposed near the bead cores 5. The outer carcass layer 4B may extend as far as the undersides of the bead cores 5, but do not extend outward in the tire radial direction from the innermost ends of the bead cores 5 in the radial direction.

In the pneumatic tire described above, both ends of the inner carcass layer 4A are folded back from the tire inner side to the tire outer side around the bead cores 5, and the folded back portions 4Ay of the inner carcass layer 4A extend to positions overlapping the innermost belt layer 7A, while both ends of the outer carcass layer 4B terminate at the bead portions 3 without being folded back around the bead cores 5, with the result that the carcass layers 4 form a three-ply structure at the side wall portions 2 that ensures sufficient rigidity on the part of the pneumatic tire, allowing for excellent steering stability.

Meanwhile, only the two carcass layers 4A, 4B are used for the framework of the tire, eliminating as much of the excess portions of the carcass layers 4 as possible, with the result that the tire weight can be reduced compared to a pneumatic tire provided with three carcass layers as in the prior art. In particular, because the folded back portions 4Ay of the inner carcass layer 4A extend to positions overlapping the innermost belt layer 7A, it is possible for the carcass layers 4 to form a three-ply structure at the side wall portions 2 while forming a two-ply structure in the region underneath the belt layers 7 in the tread portion 1. In addition, because both ends of the outer carcass layer 4B are not folded back around the bead cores 5, the weight around the bead portions 3 can be reduced. This allows the tire weight to be reduced, thereby concurrently reducing the rolling resistance of the tire.

Moreover, in accordance with the pneumatic tire described above, there are ends (4Ae, 4Be) of the carcass layers 4 at two locations per side of the tire, one of which is at a position at which there is little strain between the innermost belt layer 7A and the outer carcass layer 4B, thereby suppressing separation failure originating from the ends of the carcass layers 4 and allowing for improved separation resistance.

In the pneumatic tire described above, the height FH of the bead fillers 6 in the tire radial direction preferably has a relationship with the cross-sectional height SH of the tire such that 0.05(SH)≦FH≦0.5(SH), more preferably such that 0.1(SH)≦FH≦0.4(SH). Setting the height FH of the bead fillers 6 in the tire radial direction within the range described above ensures high bending rigidity on the part of the bead portions 3 due to the sandwiching effect of the inner carcass layer 4A being sandwiched between the main portion 4Ax and the folded back portion 4Ay and suppresses bending deformation in the bead fillers 6 when the tire is in contact with the ground, thereby allowing for reductions in the tensile force placed upon the ends 4Be of the outer carcass layer 4B adjacent to the bead fillers 6. This arrangement improves separation resistance and suppresses heat build-up and fatigue failure in the bead fillers 6.

The height FH of the bead fillers 6 in the tire radial direction is the height of the bead fillers 6 from the innermost ends to the outermost ends thereof in the radial direction.

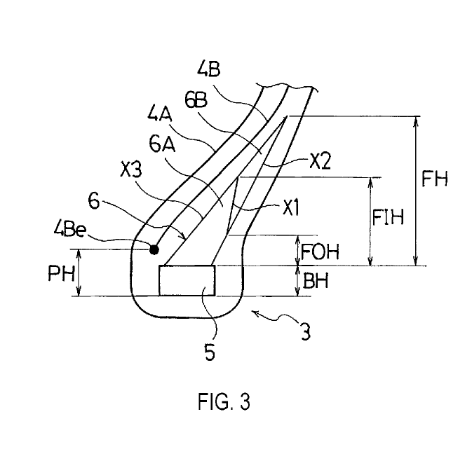

The bead fillers 6 can be formed from a single rubber composition, or from multiple types of rubber compositions having different physical properties. In particular, it is preferable that the bead fillers 6 be divided in the tire radial direction into inner fillers 6A and outer fillers 6B as illustrated in FIG. 3, the ends 4Be of the outer carcass layer 4B being disposed adjacent to the inner fillers 6A, and the outer fillers 6B having a JIS hardness that is at least three points lower than the JIS hardness of the inner fillers 6A. As a result, it is possible to reduce the proportion of the bending deformation in the bead fillers 6 that is placed upon the inner fillers 6A adjacent to the ends 4Be of the outer carcass layer 4B, allowing for a reduction in the tensile force placed upon the ends 4Be of the outer carcass layer 4B. This arrangement improves separation resistance and suppresses heat build-up and fatigue failure in the bead fillers 6. If the difference in JIS hardness between the JIS hardness of the outer fillers 6B and the JIS hardness of the inner fillers 6A is less than three points, the effects described above will be unobtainable. It is preferable for the JIS hardness of the inner fillers 6A to be set in a range from 75 to 97, and the JIS hardness of the outer fillers 6B to be set in a range from 72 to 94.

The inner fillers 6A preferably have a breaking strength of 15 MPa to 25 MPa and a loss tangent at 60° C. of 0.10 to 0.25. This suppresses heat build-up and fatigue failure in the inner fillers 6A adjacent to the ends 4Be of the outer carcass layer 4B, and allows the rolling resistance of the tire to be reduced. The inner fillers 6A will deform more readily if the breaking strength thereof is less than 15 MPa, and will exhibit fatigue failure more readily if the breaking strength exceeds 25 MPa. If the loss tangent of the inner fillers 6A at 60° C. exceeds 0.25, heat build-up due to deformation will occur more readily, a factor that leads to increased rolling resistance.

As illustrated in FIG. 3, the height FOH in the tire radial direction at the intersection between a boundary line X1 separating the inner filler 6A and the outer filler 6B and an outer contour line X2 (contour line of the outer sidewall with respect to the tire width direction) of the bead filler 6 and the height FIH in the tire radial direction at the intersection between the boundary line X1 separating the inner filler 6A and the outer filler 6B and an inner contour line X3 (contour line of the inner sidewall with respect to the tire width direction) of the bead fillers 6 as seen in a meridian cross-sectional view of the tire preferably have a relationship with the height FH of the bead filler 6 in the tire radial direction such that 0.1(FH)≦FOH≦0.4(FH) and 0.6(FH)≦FIH≦0.9(FH), respectively. Having the boundary line X1 separating the inner filler 6A and the outer filler 6B be oblique with respect to the tire width direction (i.e., the axial direction of the tire) according to the relationships described above creates a gradual change in the rigidity of the bead filler 6 along the tire radial direction, mitigates stress concentration at the boundary between the inner filler 6A and the outer filler 6B, and improves separation resistance. If the heights FOH, FIH are not within the ranges described above, it will be difficult to make the rigidity balance of the bead fillers 6 appropriate, reducing effectiveness in improving separation resistance.

The height PH of the bead core 5 in the tire radial direction from the innermost end in the tire radial direction to the end 4Be of the outer carcass layer 4B preferably has a relationship with the height FIH in the tire radial direction at the intersection between the boundary line X1 separating the inner filler 6A and the outer filler 6B and the inner contour line X3 of the bead filler 6 and the height BH of the bead core 5 in the tire radial direction such that 0.05×(BH+FIH)≦PH≦0.7×(BH+FIH). This makes the positions of the ends 4Be of the outer carcass layer 4B appropriate and allows for improved separation resistance. If PH≦0.05×(BH+FIH), the ends 4Be of the outer carcass layer 4B may be disposed below the bead cores 5 as the result of manufacturing error, potentially destabilizing tire performance factors. If PH>0.7×(BH+FIH), the contact length between the outer carcass layer 4B and the inner fillers 6A will decrease, reducing effectiveness in improving separation resistance.

The height BH of the bead cores 5 in the tire radial direction is the height of the bead cores 5 in the tire radial direction from the innermost ends to the outermost ends thereof in the radial direction. The bead cores 5 used may have, for example, square or hexagonal cross-sectional shapes, but are not particularly limited to such shapes. In any case, the height BH of the bead cores 5 in the tire radial direction is defined as specified above.

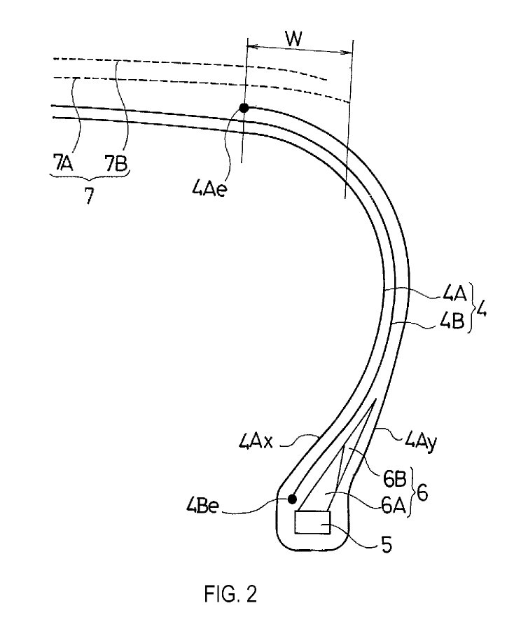

As illustrated in FIG. 2, the overlap W between the folded back portion 4Ay of the inner carcass layer 4A and the innermost belt layer 7A is preferably from 5 mm to 40 mm. This ensures excellent separation resistance. If the overlap W is less than 5 mm, the end 4Ae of the inner carcass layer 4A and the end of the innermost belt layer 7A will be close together, reducing effectiveness in improving separation resistance; conversely, if the overlap W exceeds 40 mm, the amount of carcass layer 4 used will increase, reducing effectiveness in reducing rolling resistance.

The overlap W is the width from a reference line of the innermost belt layer 7A when a reference line that passes through the end 4Ae of the inner carcass layer 4A and is orthogonal to the innermost belt layer 7A is found.

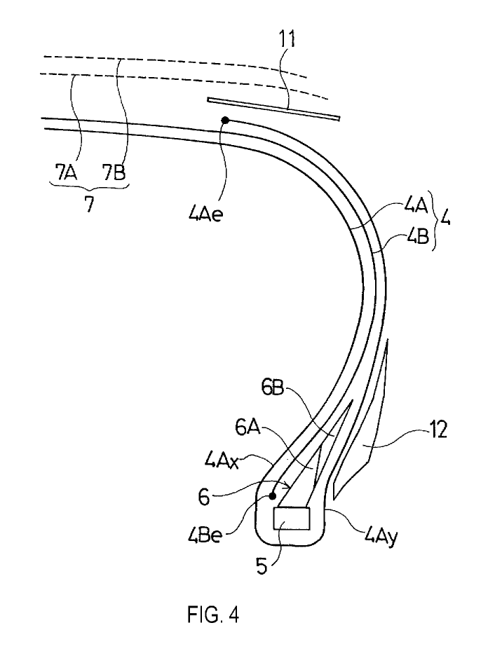

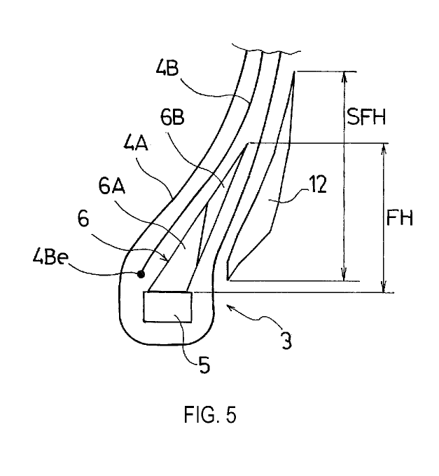

FIGS. 4 to 5 illustrate pneumatic tires according to other embodiments of the present technology. In FIGS. 4 and 5, elements identical to those illustrated in FIGS. 1 to 3 will be labeled with the same reference numerals, and detailed descriptions thereof will be omitted.

As illustrated in FIG. 4, a cushioning rubber layer 11 is disposed between the folded back portion 4Ay of the inner carcass layer 4A and the innermost belt layer 7A. The cushioning rubber layer 11 has a thickness of 0.5 mm to 2 mm and a breaking strength of at least 20 MPa. The addition of this cushioning rubber layer 11 mitigates shearing strain at the location in question, allowing for improved separation resistance. If the thickness of the cushioning rubber layer 11 is less than 0.5 mm, the effectiveness in improving separation resistance will be reduced; conversely, if the thickness exceeds 2 mm, the increase in weight will reduce effectiveness in reducing rolling resistance. If the breaking strength of the cushioning rubber layer 11 is less than 20 MPa, effectiveness in improving separation resistance will be reduced.

It is preferable that the outer end of the cushioning rubber layer 11 in the tire width direction be disposed further outward in the tire width direction than the end of the innermost belt layer 7A, and that the inner end of the cushioning rubber layer 11 in the tire width direction be disposed further inward in the tire width direction than the end 4Ae of the folded back portion 4Ay of the inner carcass layer 4A. This allows for effective mitigation of shearing strain at the location in question.

Meanwhile, a supplementary filler 12 is provided further outward in the tire width direction than the folded back portion 4Ay of the inner carcass layer 4A in the bead portion 3. The supplementary filler 12 is embedded between a side wall rubber layer or rim cushion rubber layer (not illustrated in the drawings) disposed on the outer surface of the tire and the folded back portion 4Ay of the inner carcass layer 4A. The JIS hardness of the supplementary filler 12 is set at least three points lower than the JIS hardness of the inner filler 6A. The addition of this supplementary filler 12 suppresses bending deformation of the bead filler 6 and allows the tensile force placed upon the end 4Be of the outer carcass layer 4B to be reduced. This arrangement improves separation resistance and suppresses heat build-up and fatigue failure in the bead fillers 6. If the difference in JIS hardness between the JIS hardness of the supplementary filler 12 and the JIS hardness of the inner filler 6A is less than three points, the effects described above will be unobtainable. It is preferable that the JIS hardness of the supplementary filler 12 be set in a range from 72 to 94. The same rubber composition forming the outer fillers 6B may be used as the rubber composition forming the supplementary fillers 12.

It is preferable that the outer ends of the supplementary fillers 12 in the tire radial direction be disposed further outward in the tire radial direction than the outer ends of the bead fillers 6 in the tire radial direction, and that the inner ends of the supplementary fillers 12 in the tire radial direction be disposed within the range of the height FH of the bead fillers 6 in the tire radial direction. This arrangement allows for the effective suppression of bending deformation in the bead fillers. In other words, disposing the supplementary fillers 12 at positions that are shifted outward in the tire radial direction with respect to the bead fillers 6 allows for the effective suppression of bending deformation in the bead portions 3 at the rim flanges.

It is preferable that the height SFH of the supplementary fillers 12 in the tire radial direction have a relationship with the height FH of the bead fillers 6 in the tire radial direction such that 0.5(FH)≦SFH≦1.5(FH), that the supplementary fillers 12 have a crescent-moon shape that grows progressively thinner on both sides in the tire radial direction, and that the section of maximum thickness of the supplementary fillers 12 be disposed within the range of the height FH of the bead fillers 6 in the tire radial direction. This arrangement effectively suppresses bending deformation of the bead fillers 6 without excessively increasing weight, allowing for improved durability. If SFH<0.5(FH), the effects described above will be unobtainable; conversely, if SFH>1.5(FH), the excessive increase in weight will present a factor leading to increased rolling resistance. If the supplementary filler 12 does not have a crescent-moon cross-sectional shape, but rather has a constant thickness in the tire radial direction, the excessive increase in weight will present a factor leading to increased rolling resistance. For similar reasons, the maximum thickness of the supplementary filler 12 is preferably set to 6 mm or less.

In the embodiment described above, a cushioning rubber layer 11 is provided in the tread portion 1 and supplementary fillers 12 are provided in the bead portions 3, but it is not necessary to provide both simultaneously; it is acceptable to provide only one or the other.

### EXAMPLES

Pneumatic tires according to a Conventional Example, Comparative Examples 1 and 2, and Working Examples 1 to 7 with a size of 225/70R16 in which multiple carcass layers including multiple carcass cords were laid between a pair of bead portions, bead cores and bead fillers were disposed in the bead portions, and two belt layers were disposed on the outer circumferential sides of the carcass layers were produced using different carcass layer structures.

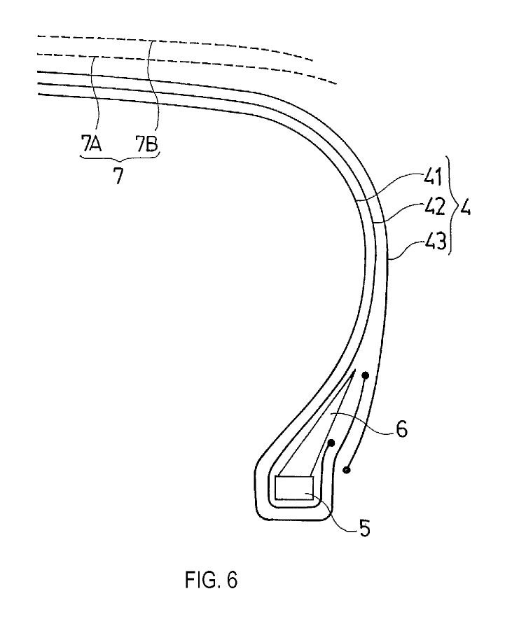

The tire of the Conventional Example had a structure using three carcass layers (see FIG. 6), with both ends of the inner carcass layers (first ply and second ply) being folded back around the bead cores, while both ends of the outer carcass layer (third ply) terminated at the bead portions without being folded back around the bead cores.

The tire of Comparative Example 1 had a structure using two carcass layers, with both ends of the inner carcass layer (first ply) being folded back around the bead cores and the ends of the folded back portions of the inner carcass layer being disposed between the innermost belt layer and the outer carcass layer, while both ends of the outer carcass layer (second ply) terminated without being folded back around the bead cores. In Comparative Example 1, both ends of the outer carcass layer did not reach the bead fillers.

The tire of Comparative Example 2 had a structure using two carcass layers, with both ends of the inner carcass layer (first ply) being folded back around the bead cores, while both ends of the outer carcass layer (second ply) were disposed so as to pass between the main portion of the inner carcass layer and the bead fillers, and both ends of the outer carcass layer terminating at the bead portions without being folded back around the bead cores. In Comparative Example 2, the ends of the folded back portions of the inner carcass layer did not reach positions overlapping the innermost belt layer.

The tires of Working Examples 1 to 7 had structures using two carcass layers (see FIGS. 1 to 5) with both ends of the inner carcass layer (first ply) being folded back around the bead cores and the ends of the folded back portions of the inner carcass layer being disposed between the innermost belt layer and the outer carcass layer, while both ends of the outer carcass layer (second ply) were disposed so as to pass between the main portion of the inner carcass layer and the bead fillers, and both ends of the outer carcass layer terminated at the bead portions without being folded back around the bead cores.

In the tires of Working Examples 3 to 7 in particular, the bead fillers comprised inner fillers and outer fillers. In the tire of Working Example 6, a cushioning rubber layer was disposed between the folded back portions of the inner carcass layer and the innermost belt layer. In the tire of Working Example 7, a cushioning rubber layer was disposed between the folded back portions of the inner carcass layer and the innermost belt layer, and supplementary fillers were disposed further outward in the tire width direction than the folded back portions of the inner carcass layer in the bead portions.

In the Conventional Example, Comparative Examples 1 and 2, and Working Examples 1 to 7 described above, the end positions (i.e., distances outward in the tire radial direction from the outermost ends of the bead cores in the tire radial direction) of the carcass layers (first to third plies), the ratio (FH/SH) of the height FH of the bead filler in the tire radial direction to the cross-sectional height SH of the tire, the JIS hardness of the bead fillers, the breaking strength of the bead fillers, and the loss tangents of the bead fillers at 60° C. were set as shown in Table 1.

In Working Examples 1 to 7 and Comparative Example 1, the overlap W between the folded back portions of the inner carcass layer and the innermost belt layer was 30 mm. In Working Examples 1 to 7 and Comparative Example 2, the height PH in the tire radial direction from the innermost ends of the bead cores in the tire radial direction to the ends of the outer carcass layer was set so that PH/(BH+FIH)=0.5. In Working Examples 3 to 7, the height FOH in the tire radial direction at the intersection between the boundary line separating the inner filler from the outer filler and the outer contour line of the bead filler was set so that FOH/FH=0.2, and the height FIH in the tire radial direction at the intersection between the boundary line separating the inner filler from the outer filler and the inner contour line of the bead filler was set so that FIH/FH=0.7. In Working Examples 6 and 7, the thickness of the cushioning rubber layer was 1.0 mm, and the breaking strength thereof was 10 MPa. In Working Example 7, the JIS hardness of the supplementary fillers was 85.

The various test tires were evaluated for separation resistance, tire weight, rolling resistance, and steering stability according to the following evaluation methods; results are shown in Table 1.

Separation Resistance:

The test tires were assembled on wheels having a rim size of 16×6½JJ which were mounted on a drum durability tester, a driving test was performed at an air pressure of 400 kPa, a load of 11.8 kN, and a speed of 80 km/h, and the traveling distance until separation failure of the carcass layers occurred was measured. Evaluation results were expressed as index values, with the Conventional Example being 100. Larger index values indicate superior separation resistance performance.

Tire Weight

The weight of each test tire was measured. The evaluation results were expressed, using the inverse value as the measurement value, as index values with the Conventional Example being 100. Larger index values indicate correspondingly lower tire weight.

Rolling Resistance

The test tires were assembled on wheels having a rim size of 16×6½JJ which were mounted on a rolling resistance tester provided with a 854 mm-radius drum, and pre-driving was performed for 30 minutes at an air pressure of 210 kPa, a load of 6.47 kN, and a speed of 80 km/h, after which rolling resistance was measured under the same conditions. The evaluation results were expressed, using the inverse value as the measurement value, as index values with the Conventional Example being 100. Higher index values indicate lower rolling resistance.

Steering Stability

The test tires were assembled on wheels having a rim size of 16×6½JJ which were mounted on a test vehicle, and sensory evaluations were performed by a test driver on a test course at an air pressure of 210 kPa. Evaluation results were expressed as index values, with the Conventional Example being 100. Larger index values indicate better steering stability.

TABLE 1

| | Conventional | Comparative | Comparative | Working | Working |
|---|---|---|---|---|---|
| | Example | Example 1 | Example 2 | Example 1 | Example 2 |
| End position of first | 75 | 160 | 50 | 160 | 160 |
| ply (mm) | | | | | |
| End position of second | 15 | 80 | 30 | 30 | 30 |
| ply (mm) | | | | | |
| End position of third | 5 | — | — | — | — |
| ply (mm) | | | | | |
| FH/SH | 0.03 | 0.03 | 0.03 | 0.03 | 0.3 |
| JIS hardness of bead | 90 | 90 | 90 | 90 | 90 |
| fillers | | | | | |
| (inner/outer) | | | | | |
| Breaking strength of | 13 | 13 | 13 | 13 | 13 |
| bead fillers (MPa) | | | | | |
| (inner/outer) | | | | | |
| Loss tangent of bead | 0.32 | 0.32 | 0.32 | 0.32 | 0.32 |
| fillers | | | | | |
| (inner/outer) | | | | | |
| Cushioning rubber | No | No | No | No | No |
| layer present? | | | | | |
| Supplementary fillers | No | No | No | No | No |
| present? | | | | | |
| Separation resistance | 100 | 96 | 98 | 110 | 113 |
| (index) | | | | | |
| Tire weight (index) | 100 | 112 | 116 | 110 | 108 |
| Rolling resistance | 100 | 106 | 108 | 105 | 104 |
| (index) | | | | | |
| Steering Stability | 100 | 90 | 90 | 100 | 104 |
| (index) | | | | | |
| | Working | Working | Working | Working | Working |
| | Example 3 | Example 4 | Example 5 | Example 6 | Example 7 |
| End position of first | 160 | 160 | 160 | 160 | 160 |
| ply (mm) | | | | | |
| End position of second | 30 | 30 | 30 | 30 | 30 |
| ply (mm) | | | | | |
| End position of third | — | — | — | — | — |
| ply (mm) | | | | | |
| FH/SH | 0.3 | 0.3 | 0.3 | 0.3 | 0.3 |
| JIS hardness of bead | 90/85 | 85/90 | 90/85 | 90/85 | 90/85 |
| fillers | | | | | |
| (inner/outer) | | | | | |
| Breaking strength of | 13/12 | 12/13 | 23/18 | 23/18 | 23/18 |
| bead fillers (MPa) | | | | | |
| (inner/outer) | | | | | |
| Loss tangent of bead | 0.32/0.25 | 0.25/0.32 | 0.18/0.17 | 0.18/0.17 | 0.18/0.17 |
| fillers | | | | | |
| (inner/outer) | | | | | |
| Cushioning rubber | No | No | No | Yes | Yes |
| layer present? | | | | | |
| Supplementary fillers | No | No | No | No | Yes |
| present? | | | | | |
| Separation resistance | 115 | 108 | 117 | 119 | 120 |
| (index) | | | | | |
| Tire weight (index) | 108 | 108 | 108 | 107 | 106 |
| Rolling resistance | 104 | 104 | 106 | 105 | 104 |
| (index) | | | | | |
| Steering Stability | 104 | 99 | 104 | 104 | 105 |
| (index) | | | | | |

As can be seen from Table 1, the tires of Working Examples 1 to 7 allowed for reductions in tire weight and rolling resistance compared to the Conventional Example while maintaining excellent steering stability, and also allowed for improved separation resistance.

Meanwhile, in the tire of Comparative Example 1, both ends of the outer carcass layer did not reach the bead fillers, and both ends of the outer carcass layer were not disposed so as to pass between the main portion of the inner carcass layer and the bead fillers, with the result that steering stability was worse than in the Conventional Example, and separation resistance also decreased. In the tire of Comparative Example 2, the ends of the folded back portions of the inner carcass layer did not reach positions overlapping the innermost belt layer, with the result that steering stability was worse than in the conventional example, and separation resistance also decreased.

1. A pneumatic tire comprising:
two carcass layers including a plurality of carcass cords laid between a pair of bead portions;
bead cores and bead fillers disposed in the bead portions; and
at least two belt layers disposed on an outer circumferential side of the carcass layers,
both ends of the inner carcass layer being folded back from a tire inner side to a tire outer side around the bead cores, and the ends of the folded back portions of the inner carcass layer being disposed between the innermost belt layer and the outer carcass layer, while both ends of the outer carcass layer being disposed so as to pass between a main portion of the inner carcass layer and the bead fillers, and both ends of the outer carcass layer terminated at the bead portions without being folded back around the bead cores.

2. The pneumatic tire according to claim 1, wherein the height FH of the bead fillers in the tire radial direction has a relationship with the cross-sectional height SH of the tire such that 0.05(SH)≦FH≦0.5(SH).

3. The pneumatic tire according to claim 1, wherein the bead fillers are divided in the tire radial direction into inner fillers and outer fillers, the ends of the outer carcass layer are disposed adjacent to the inner fillers, and the outer fillers have a JIS hardness that is at least three points lower than the JIS hardness of the inner fillers.

4. The pneumatic tire according to claim 3, wherein the inner fillers have a breaking strength of 15 MPa to 25 MPa and a loss tangent at 60° C. of 0.10 to 0.25.

5. The pneumatic tire according to claim 3, wherein the height FOH in the tire radial direction at intersections between boundary lines separating the inner fillers and the outer fillers and outer contour lines of the bead fillers and the height FIH in the tire radial direction at intersections between the boundary lines separating the inner fillers and the outer fillers and inner contour lines of the bead fillers have relationships with the height FH of the bead filler in the tire radial direction such that 0.1(FH)≦FOH≦0.4(FH) and 0.6(FH)≦FIH≦0.9(FH), respectively.

6. The pneumatic tire according to claim 3, wherein the height PH of the bead cores in the tire radial direction from the innermost ends thereof in the tire radial direction to the ends of the outer carcass layer has a relationship with the height FIH in the tire radial direction at the intersection between the boundary lines separating the inner fillers and the outer fillers and the inner contour lines of the bead fillers and the height BH of the bead cores in the tire radial direction such that 0.05×(BH+FIH)≦PH≦0.7×(BH+FIH).

7. The pneumatic tire according to claim 1, wherein the overlap W between the folded back portions of the inner carcass layer and the innermost belt layer is from 5 mm to 40 mm.

8. The pneumatic tire according to claim 1, wherein a cushioning rubber layer having a thickness of 0.5 mm to 2 mm and a breaking strength of at least 20 MPa is disposed between the folded back portions of the inner carcass layer and the innermost belt layer.

9. The pneumatic tire according to claim 8, wherein the outer ends of the cushioning rubber layer in the tire width direction are disposed further outward in the tire width direction than the ends of the innermost belt layer, and the inner ends of the cushioning rubber layer in the tire width direction are disposed further inward in the tire width direction than the ends of the folded back portions of the inner carcass layer.

10. The pneumatic tire according to claim 3, wherein supplementary fillers having a JIS hardness that is at least three points less than that of the inner fillers is provided further outward in the tire width direction than the folded back portions of the inner carcass layer in the bead portions.

11. The pneumatic tire according to claim 10, wherein the outer ends of the supplementary fillers in the tire radial direction are disposed further outward in the tire radial direction than the outer ends of the bead fillers in the tire radial direction, and the inner ends of the supplementary fillers in the tire radial direction are disposed within the range of the height FH of the bead fillers in the tire radial direction.

12. The pneumatic tire according to claim 10, wherein the height SFH of the supplementary fillers in the tire radial direction has a relationship with the height FH of the bead fillers in the tire radial direction such that 0.5(FH)≦SFH≦1.5(FH), the supplementary fillers are shaped so as to grow progressively thinner on both sides in the tire radial direction, and the section of maximum thickness of the supplementary fillers are disposed within the range of the height FH of the bead fillers in the tire radial direction.

13. The pneumatic tire according to claim 2, wherein the bead fillers are divided in the tire radial direction into inner fillers and outer fillers, the ends of the outer carcass layer are disposed adjacent to the inner fillers, and the outer fillers have a JIS hardness that is at least three points lower than the JIS hardness of the inner fillers.

14. The pneumatic tire according to claim 13, wherein the inner fillers have a breaking strength of 15 MPa to 25 MPa and a loss tangent at 60° C. of 0.10 to 0.25.

15. The pneumatic tire according to claim 14, wherein the height FOH in the tire radial direction at intersections between boundary lines separating the inner fillers and the outer fillers and outer contour lines of the bead fillers and the height FIH in the tire radial direction at intersections between the boundary lines separating the inner fillers and the outer fillers and inner contour lines of the bead fillers have relationships with the height FH of the bead filler in the tire radial direction such that 0.1(FH)≦FOH≦0.4(FH) and 0.6(FH)≦FIH≦0.9(FH), respectively.

16. The pneumatic tire according to claim 15, wherein the height PH of the bead cores in the tire radial direction from the innermost ends thereof in the tire radial direction to the ends of the outer carcass layer has a relationship with the height FIH in the tire radial direction at the intersection between the boundary lines separating the inner fillers and the outer fillers and the inner contour lines of the bead fillers and the height BH of the bead cores in the tire radial direction such that 0.05×(BH+FIH)≦PH≦0.7×(BH+FIH).

17. The pneumatic tire according to claim 16, wherein the overlap W between the folded back portions of the inner carcass layer and the innermost belt layer is from 5 mm to 40 mm.

18. The pneumatic tire according to claim 17, wherein a cushioning rubber layer having a thickness of 0.5 mm to 2 mm and a breaking strength of at least 20 MPa is disposed between the folded back portions of the inner carcass layer and the innermost belt layer.

19. The pneumatic tire according to claim 18, wherein the outer ends of the cushioning rubber layer in the tire width direction are disposed further outward in the tire width direction than the ends of the innermost belt layer, and the inner ends of the cushioning rubber layer in the tire width direction are disposed further inward in the tire width direction than the ends of the folded back portions of the inner carcass layer.

20. The pneumatic tire according to claim 19, wherein supplementary fillers having a JIS hardness that is at least three points less than that of the inner fillers is provided further outward in the tire width direction than the folded back portions of the inner carcass layer in the bead portions.
